(19) United States
(12) Patent Application Publication
(10) Pub. No.: US 2023/0269438 A1
(43) Pub. Date: Aug. 24, 2023

(54) INTERACTIVE TELEVISION USING SET TOP BOX AND CLOUD STORE

(71) Applicants: DISH NETWORK TECHNOLOGIES INDIA PRIVATE LIMITED, Bengaluru (IN); DISH NETWORK L.L.C., Englewood, CO (US)

(72) Inventors: Sahil SAINI, Aurora, CO (US); Al-Mukaddim PATHAN, Englewood, CO (US); Dmitry DIMOV, San Francisco, CA (US); Padmanabha R. RAO, Palo Alto, CA (US); Shishir PANDEY, Hyderabad (IN); Harshith BARIKI, Bangalore (IN)

(73) Assignees: DISH NETWORK TECHNOLOGIES INDIA PRIVATE LIMITED, Bengaluru (IN); DISH NETWORK L.L.C., Englewood, CO (US)

(21) Appl. No.: 17/675,618

(22) Filed: Feb. 18, 2022

(51) Int. Cl. H04N 21/482; H04N 21/472; H04N 21/475; H04N 21/45; H04N 21/478

(52) U.S. Cl. CPC H04N 21/482; H04N 21/47202; H04N 21/4753; H04N 21/4524; H04N 21/478

(57) ABSTRACT

A set top box is disclosed that delivers content from a television service provider to a user, the content being developed by a third party service provider. The set top box includes a receiver for onboarding an application to the set top box from a cloud store over a network. The application is onboarded to the cloud store from the third party service provider in response to the application being developed directly by the third party service provider using an interface provided by the television service provider in the cloud store. The set top box also includes an interface for transmitting a request from the user for content through the application to a television of the user over the network. Then, in response to receiving the request from the set top box, the receiver receives from the television service provider to the set top box content requested by the user.

### BACKGROUND

Currently, almost every household has a television and receives content as a one way content receiver—content is transferred from the television service provider to a consumer. For example, if a consumer wants to watch a television program, she will tune the television to the television channel at the scheduled programming time and she will watch the received content. In this regard, television is primarily a one way (receive only) entertainment service provided to the consumer.

However, consumers currently do not have a television system which is fully integrated automatically with third-party providers in a two-way interactive entertainment manner.

### SUMMARY

Various embodiments provide solutions to allow a set top box and television of a user to communicate bi-directionally by providing a cloud-based platform having a marketplace that allows third-party service providers (e.g., neighborhood yoga instructor, local hospital provider, national gym, etc.) to develop applications for two-way communications between users and delivery of the third party service provider services to the users via television.

In some embodiments, the television service provider provides a cloud-based marketplace where a third-party can select functions from a service catalogue in order to customize an application that will be used by the user. This application is then deployed to the set top box with settings (e.g., for particular geographical locations), and the television service provider can offer ancillary promotions as selected by the third-party providers to enhance their applications visibility on a user's television.

This cloud-based marketplace allows the television service provider to provide a service (at no cost to the user) that converts the television from a one-way entertainment source to a two-way interactive engagement and customizable system.

According to an embodiment, disclosed is a set top box that delivers content from a television service provider to a user's television where the application is developed by a third party service provider. The set top box includes a receiver for onboarding an application to the set top box of the user from a TV service provider's cloud store over a network. The application has been onboarded to the cloud store from the third party service provider in response to the application being developed directly by the third party service provider using an interface provided by the TV service provider in the cloud store. The set top box also includes an interface for transmitting a request from the set top box of the user through the third party application over the network to initiate a two-way engagement.

According to another embodiment, a method is provided of delivering an application that is developed by the third party service provider from a television service provider to a set top box of a user's television. The method includes providing a first interface in a cloud store for the third party service provider to onboard their application; receiving, from the third party service provider, (1) feature data to build the application using the first interface in the TV service provider cloud store, and (2) user-identifying data indicating the set top box of the user is authorized to receive the third party application; building the application using the feature data by the third party service provider; identifying, by the television service provider, the target user by comparing the received user-identifying data with data in a database of the television service provider; and in response to successfully identifying the user, onboarding the application to the user's set top box from a server of the TV provider cloud store so that when the user views an interface on the user's set top box, the application is available and usable by the user to request services from third party application through the user's set top box.

According to another embodiment, a method is provided for delivering content via an application of a third party service provider from a television service provider to a set top box of a user, where the content being developed by the third party service provider. The method includes providing a first interface in a cloud store for onboarding an application of a third party service provider, the first interface comprising a feature set of features and each feature within the feature set comprising a set of functions that are individually selectable by the third party provider; receiving, from the third party service provider using a canvas in the first interface, a selection of functions that will be used to build the application in the cloud store; building, by the television service provider, the application using the selection of functions from the third party service provider; storing the application in the cloud store; associating the application with the user in a database at a server associated with the cloud store; receiving a request from the user for content from the user's set top box, the request being performed through the application; and delivering the requested content to the user's set top box.

### BRIEF DESCRIPTION OF THE DRAWINGS

FIG. 1 illustrates a block diagram of components (features and functions) of a cloud store according to some embodiments.

FIG. 2 illustrates a system of a cloud store and a system of building the application by third party and delivering content according to some embodiments.

FIG. 3 illustrates a block diagram of features of a cloud store eco-system according to some embodiments.

FIG. 4 illustrates a system of onboarding an application and delivering content according to some embodiments.

FIG. 5 illustrates a method of creating and onboarding an application by a third party service provider according to some embodiments.

FIG. 6 illustrates a method of onboarding an application to a set top box of a user and delivering content according to some embodiments.

FIG. 7 illustrates a block diagram illustrating a monetary flow of money and charges between a user, a TV service provider, and a third party service provider using the system of the present application according to some embodiments.

FIG. 8 illustrates a method of creating, onboarding, and using an application in order to show the simplicity of use for a user and delivering content according to some embodiments.

### DETAILED DESCRIPTION OF EMBODIMENTS

As mentioned above, various embodiments provide solutions to allow the television and gateway of a user to allow bidirectional communication by providing a cloud-based platform having a marketplace that allows third party service providers (e.g., neighborhood yoga instructor, local hospital provider, national gym, etc.) to provide services to the users via an application created by such third party service providers (without hiring a programmer). In this regard, the third party service providers will be able to use the cloud-based platform to create, using their devices, their own interface that will be used by the consumers, and this interface allows the third party provider to provide a service to the consumer.

Once the application is developed by the third party server provider, the application is “pushed” or transferred to the targeted user's set top box without the user requesting such applications and without any cost to the user, according to some embodiments. This can provide a seamless and simple experience for the user.

Also, the third party services that the user is enrolled in are integrated into the experience with the television programming according to an embodiment. For example, if a user is also enrolled in a local yoga instructor application, the user may get a notification that the yoga class is starting in 30 minutes while the user is watching her favorite TV program (e.g. via a banner below, beside, or over the program at the same time the program is being played to the user via the user's electronic device). In this regard, the user can then click the notice regarding the yoga class and be routed directly to the yoga class.

More details on these and other embodiments and features are discussed in more depth below with regard to the figures.

It should be noted that while the term “third party service provider” is used herein, it should be understood that the third party service provider may be any entity, including developers which are not owners and managers of the television service provider, the television service provider subscribers which are configured to receive television content from the television service provider, or any other users of the system of the television service provider. For example, a yoga instructor may be considered a third party service provider because the yoga instructor is a party that could be separate from the television service provider and an end user receiving the television content. It should be noted that the third party service provider could not only be a provider of television content to the system but also receive television content from the television service provider and receive content from other third party service providers through the television service provider system. In one embodiment, the third party service provider may be an end user of the television service provider. In this regard, the term “third party service provider” is not intended to limited and may be any entity separate from the television service provider.

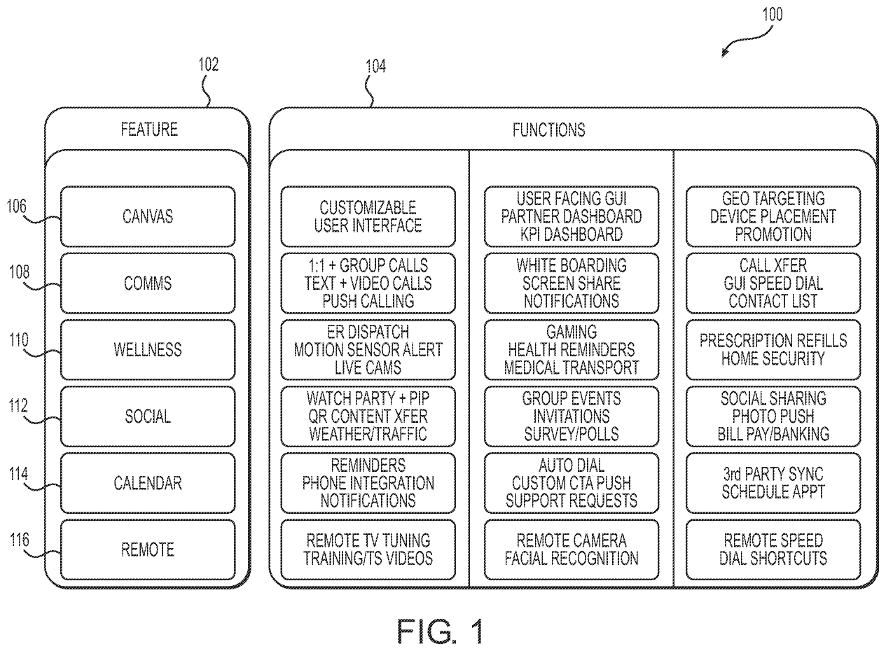

As mentioned above, the television service provider provides a cloud-based marketplace (also referred to herein as a “service store” or “cloud store”) for development of applications by third party service providers and content delivery by the third party service providers through such applications. One component of this marketplace is the service store. FIG. 1 illustrates a block diagram of components of the service store according to some embodiments. The service store is a system where third-party service providers can develop an application and deliver content through to be delivered to end users, according to some embodiments.

As shown in FIG. 1, a block diagram 100 of a set of features 102 and functions 104 associated with those features 102. The set of features 102 shown in FIG. 1 include canvas 106, communications 108 (or “comms” for short), wellness 110, social 112, calendar 114, and remote 116. However, it should be understood that the present application should not be limited to the set of features 102 shown in FIG. 1 and may have more or less features.

For the canvas feature 104, a third-party provider can create an application available in the cloud-based marketplace or service store. For example, a yoga instructor could go to the service store, indicates she wants to create an application for the marketplace and starts with the canvas 106 feature of the service store.

The functions 104 of the canvas feature 106 include customizable user interface (“UI”), a user facing graphical user interface (“GUI”) with a dashboard showing various metrics, a geo-targeting device, and placement promotions. The customizable UI allows the third party service provider to select features that the third party wants in the application, as is discussed in more detail later. This customizable UI may be branded with the third party service provider brand.

The user facing GUI is the GUI that the user interacts with, and the third party service provider can customize how the interface of the third party service provider's application will look to the user and locations within the set top box from which the application can be accessed. In this regard, there can be features added that the user can interact with (e.g., settings, notifications, content requests, etc.) as well as the style and branding of the user facing GUI. The user facing GUI can also collect and provide various metrics to the third party as well based on interactions with users. For example, a yoga instructor can determine how many classes enrolled users are attending, how often each user attends a particular class, where on the set top box that the user is accessing the third party application from, etc.

Other information can be collected by the user facing GUI, including interests/preferences of each individual user and other information/settings based on interactions that the user has with the application. For example, the user facing application can provide data to the third party service provider relative to what the user is viewing, what items within the third party application the user is clicking on, view times, etc. This information can be collected through interactions between the users and the customizable application in the cloud-based marketplace.

The other functions for the canvas feature 106 include “geo targeting,” which allows the third party service provider to set a specific geographical location to market the application to. For example, if the yoga instructor is located in Denver, Colorado, the yoga instructor could set the geographic preference to be the subscribers only in the Denver metropolitan area so that those in California, for example, would not be able to access the application or receive content through the application for that particular yoga instructor. Taking into consideration geographic relationships can allow for the third party service provider to optimize the likelihood of reaching target customers. Alternatively, the third party service provider could state that there is no geographical preference and thus, the application would be available to users located in any geographic location.

There are also various other features that can be included in the canvas feature 106 as well including various promotions and device placement, as will be explained later herein.

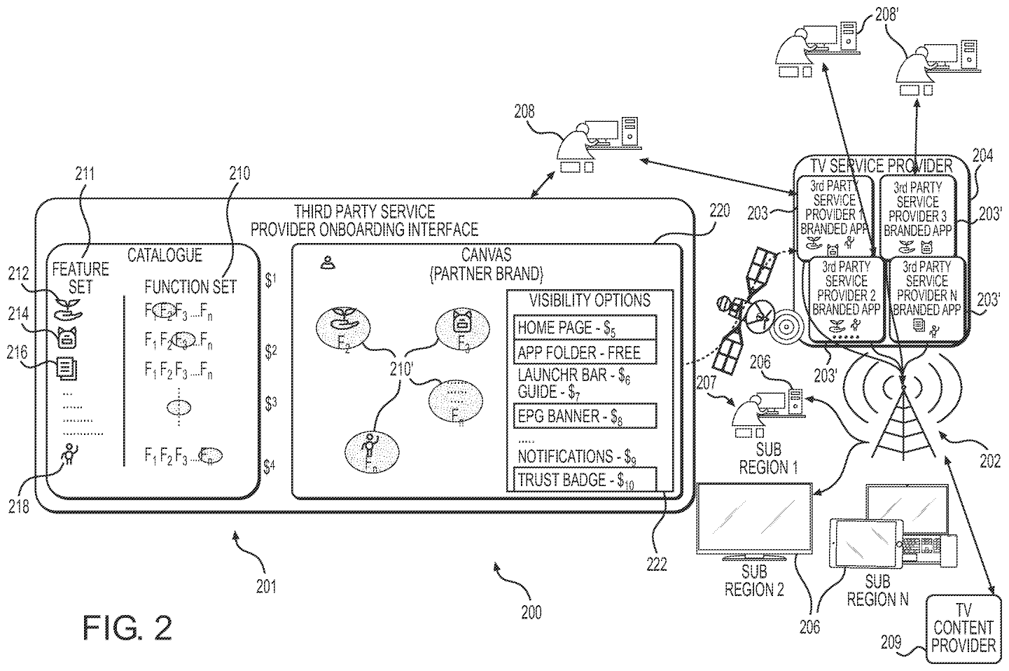

More details on the canvas feature 106 are described in more depth later herein with regard to FIG. 2.

Each of the other features 108-116 shown in the block diagram 100 of FIG. 1 has sets of functions 104 as well. For example, the communications feature 108 has the following functions: (1) allow various communications between users using the user's television, such as one-on-one calls (either text, audio or video calls), push calling between devices (where a user can turn on a television of another user to call that user), etc. (2) “white-boarding” (where there is a canvas on the user's screen to write or draw content on the user's screen that is shared between users), (3) screen sharing (sharing television screens between users), (4) providing notifications to the set top box based on the application (e.g., when the user is watching programming, a notification can be displayed indicating content from the application is available to the user), (5) call transfers (transferring a call to another user using a television even while such user is watching television), (6) contact list (allowing speed dial on the television remote to program and use a contact list to make calls), and other communication functions. In this regard, various functions 106 to allow a user to communicate with other users between respective set top boxes can be provided under the communications feature 108.

For the wellness feature 110, there are also many functions 106 that can be added by the third party service provider in developing the application, including: (1) emergency dispatch using the television remote, (2) motion sensor alerting when a user is not moving more than a predefined time, (3) live cameras monitoring the user, (4) gaming between users using televisions, (5) health reminders, (6) medical transport requests, (7) prescription refills, (8) home security, etc. Each of these functions can be added to the application and use the set top box and television of the user and/or between users of televisions.

For the social feature 112, there are also many functions 106 that can be added by the third party service provider in developing the application for interactions between users and/or general data requested by the user. These may include: (1) watch party and picture-in-picture communications between users, (2) allowing multiple screens to display different content and/or television video feeds QR content transfers (where any user can scan a QR code on the television using their phone camera and the content will then start streaming on a new device of the user as long as they are subscribed to the Television service provider), (3) weather/traffic data and alerts, (4) group events, (5) invitations (e.g., invite users to a party via a television using a remote), (6) surveys/polls between users using television, (7) social sharing using televisions, (8) pushing photos between televisions, (9) bill pay/banking, etc.

For the calendar feature 114, various functions 106 exist that can be added by the third party service provider in developing the application, such as (1) reminders, (2) phone integration, (3) event notifications, (4) auto dial, (5) custom CTA push (e.g., get notification that user has completed a task scheduled for a certain time), (6) support requests, (7) third party synchronizations, (8) schedule appointments, and any other function where calendars may be employed via a set top box or a television.

For the remote feature 116, there are also many functions 106 that can be added by the third party service provider in developing the application, such as (1) remote TV tuning, (2) training videos, (3) having a camera in the remote, (4) facial recognition using the camera in the remote, (5) remote speed dial, (6) shortcuts, and any other function that can be used with the remote control of the television/set top box.

Each of the functions 104 of the canvas 106, communications 108, wellness 110, social 112 and calendar 114 features may be displayed as an icon in the canvas of the application building program that can be individually selected as part of the third party server provider's building of their application. This selecting may be the third party service provider using the GUI to drag and drop the functions from the feature set to the canvas as will be discussed in more depth with regard to FIG. 2.

FIG. 2 illustrates a system 200 of a cloud store 204 according to some embodiments. As shown, the system 200 includes a network 202 configured to host and distribute the content from the cloud store 204 and configured to communicate in various sub geographical regions 206. The cloud store 204 allows a third party service provider 208 to create an application 203 using a catalog in the GUI 201 which has certain feature categories or feature sets 211.

Each feature set 211 has its own set of functions 210 that have a plurality of functions that each can be individually selected by the third party service provider 208 for inclusion in their application creation. For example, a particular third party service provider 208 can select function F₂ of feature 212, function F₃ of feature 214, and or any function Fₙ of feature 218, but not select any of the functions of feature 216. The selected functions 210′ may be any function 210, such as any of the functions discussed above for features 106-116 or any other feature category.

The third party service provider 208 is provided with a GUI 201 to display the sets of features 211, corresponding the sets of functions 210, and canvas 220 which will allow the user 207 to interact and engage with functions 210, thereby providing a simple, user-friendly GUI whereby the third party service provider 208 can visually perceive what has been selected for programming in the application.

In this regard, the third party service provider 208 then may transfer (e.g., drag and drop, etc.), using the GUI 201, particular functions 210 to an area of the canvas 220 indicating that those particular functions 210′ are now selected and thus desired to be part of the application 203 for the third party service provider 208.

At this point, the system 200 receives a signal or message indicating which functions 210 were selected by the third party service provider 208 to include in the application 203 associated with the third party service provider 208, a confirmation the functions 210′ have been selected, user IDs of those enrolled, promotions the third party service provider wishes to be enrolled in, and any other information useful for building and onboarding the application 203. Upon receipt of the signal or message, the server of the system 200 compiles the setup to build the desired application 203 and pushes the built application 203 to the cloud store 204 along with other stored applications 203′ of other third part service providers 208′.

It should be noted that the cloud store 204 includes one or more servers and/or databases to store and/or process the applications 203, 203′, perform operations/requests/etc., and perform communications between the third party service providers 208, 208′, users 207 and the television service provider 209 (also referred to herein as the “television content provider” 209).

Moreover, the system 200 also receives certain settings 222 for visibility options, such as where the application 203 will be displayed on the television service provider's home page interface, whether the application 203 will be displayed on an electronic programming guide (“EPG”) banner or in the television viewing guide, provide notifications to the user 207 of the application 203 while the user 207 is viewing other television content, etc. The visibility options 222 allow the application 203 to have more exposure to be used by the user 207.

Also, the system 200 may also provide the third party service provider 208 additional options to make the application 203 visible and usable on a set top box 414 of the user 207. For example, for each user 207 on the set-top-box 414, the television service provider 207 can make the application 203 only accessible within a certain geographical region 206. The system 200 is configured to detect each user's location using, but not limited to, the IP addresses of users stored in the systems database (or IP address of the user when a request is received or creating a list of setup to box IDs) and then compare the user's determined location with the predefined setting indicating which geographical areas the application 203 can be used. For example, if a yoga instructor in Colorado applies a setting indicating that their application should only be viewed by those geographically in Colorado, then anyone outside of Colorado (e.g., having an IP address indicating a geographical address outside of Colorado) will not receive the application or view the application. In this regard, for example, when a user 207 in Iowa requests the yoga class from a set top box 413 located in Iowa, the system 200 will determine that the IP address associated with the set top box 413 the user 207 uses to request the yoga class is located in Iowa which is outside the set geographic area and thus, the yoga class content is prevented from being delivered to the set top box 413. However, when the user 207 sends a request from a set top box 413 that is located in Colorado (e.g., with an IP address associated with a Colorado location), the system 200 will authenticate the content request and deliver the requested content from the cloud store 204 to the set top box 413 of the user.

After all of the functions 210 are selected to be selected functions 210′ in the canvas 220 and the settings/options are set, the application 203 is then built by the system 200 and stored in a database at the cloud store 204. The system 200 uses various systems (IT systems for authentication/billing/etc., backend middleware, API gateway, encoding, RN technology stack, 5G gateway, P2P communications, etc.) to automatically build the application 203 based on a base template using the signals/messages indicating which programs (associated with the selected functions 210′ should be used to build the application) in response to receiving a message confirming the third party service provider 208 has completed selections of the functions 210′ and other settings for the application 203. In this regard, the build will be customized to include the functions 210 selected by the third party service provider 208.

The above process occurs for each third party service provider 208, 208′, and FIG. 2 illustrates that multiple customized applications 203, 203′ are stored in the cloud store 204. Each customized application 203, 203′ built by the system 200 is different for each third party service provider 208, where each customized application 203, 203′ is built directly using the GUI 201 in the cloud store 204 and built directly by the third party service provider 208 who is the same entity which delivers content through their application 203.

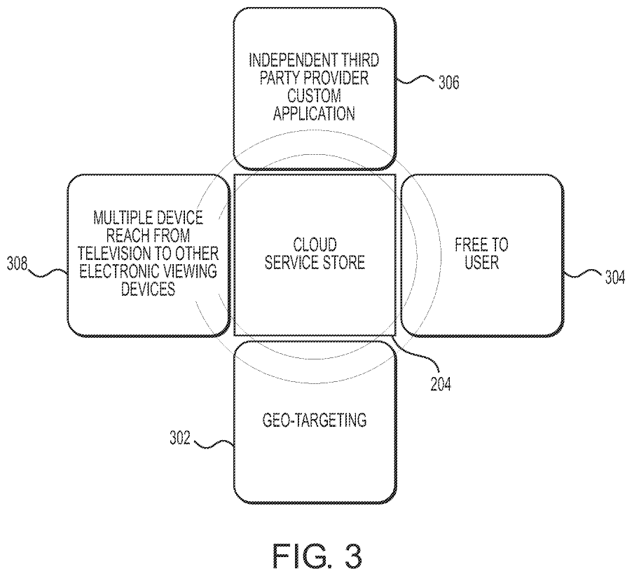

FIG. 3 illustrates a block diagram of features of the cloud store 204 and advantages of the present system 200 over previous systems, according to some embodiments. As shown, the cloud store 204 is shown in the center of FIG. 3 and is a central part of all of the features/advantages 302, 304, 306, 308.

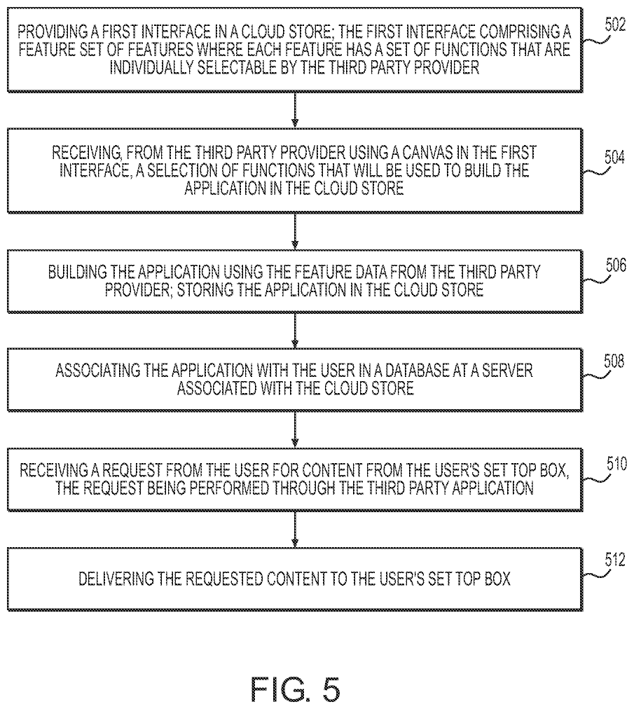

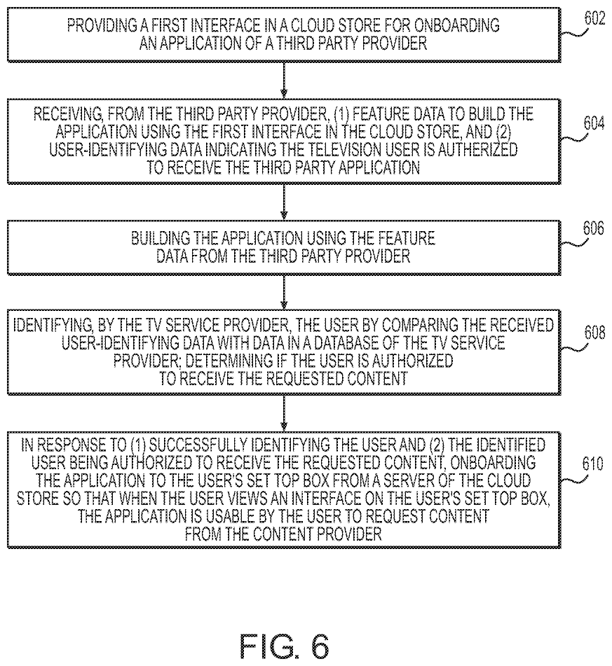

The cloud store 204 is maintained by the television service provider 209 and allows independent third party service providers 208 to create custom branded applications 203, 203′, as discussed in FIG. 2 and discussed later for FIGS. 5-6. In this regard, the third party service provider 208 directly develops the application 203 using the GUI and thus, does not have to hire an application developer to develop the application 203 for them. As such, block 306 shows that the third party service provider 208 can independently create their own application 203 using the television service provider's interface 201 discussed above with respect to FIG. 2.

Next, in block 304, the application 203 will be free (i.e., at no monetary cost) to each end user (the TV service provider reserves the right to charge the TV users in the future). The TV user and third party service provider 208 are connected together using the application 203, and the TV user simply requests and receives content through the television service provider 209. The experience for the user 207 is simplified in that the user 207 does not have request the application 203 from the television service provider 209, interact with the application directly from the TV service provider remote, the third party app is integrated with video stream actively playing on TV and the user does not have to switch inputs, enter in financial payment information, etc. The receiving, interaction, engagement of content is therefore seamless for the user 207.

As mentioned above, a feature of the cloud store 204 is geo-targeting of applications 203, 203′ whereby such applications 203, 203′ can be targeted for only a specific geographical region. Thus, in block 302, an advantage of the present system 200 is geo-targeting the application 203, 203′ for particular users 208, 208′ and such geo-targeting is performed through the cloud store 204.

Additionally, while a set top box outputting to a television is a main system that is used to receive television content, other electronic devices will also be configured to receive content from the television service provider 208 as well as content from the application 203 developed by the third party service provider 208. Thus, block 308 shows a portion of the cloud store 204 is configured to reach not only televisions, but also other electronic devices, such as cellular phones, tablets, laptops, desktops, etc. These other electronic devices could receive the content on the same network as the set top box, on a different network, or from a cellular tower or satellite system.

Other features and advantages may also be part of the present application, and the present application is not limited to those discussed and illustrated in FIG. 3. Also, the features and advantages of FIG. 3 are not requirements of the present invention and thus, the present invention should not be limited in that regard.

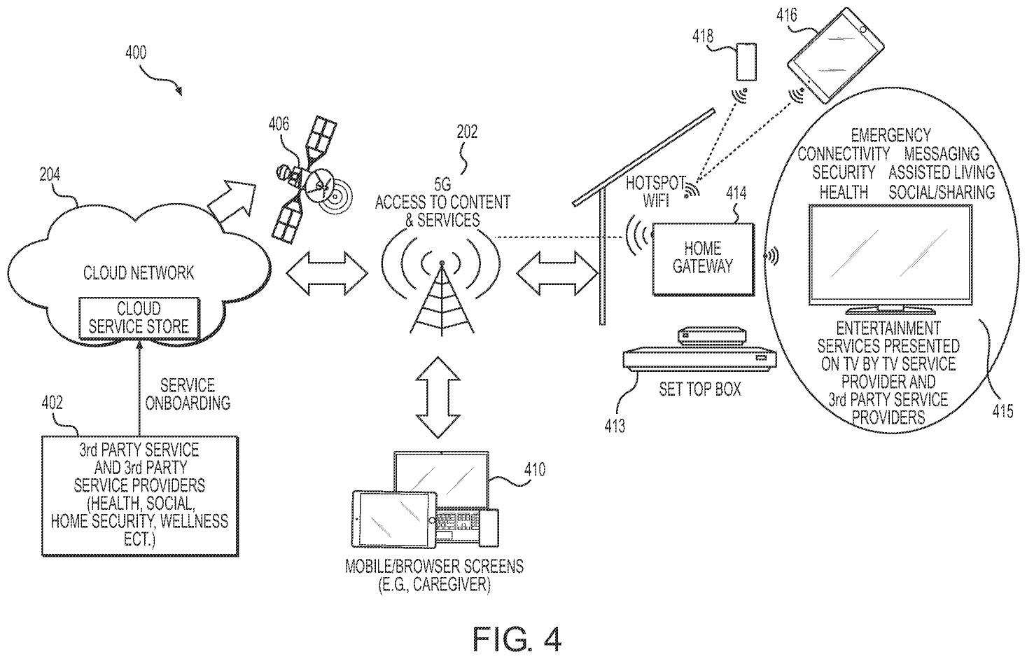

FIGS. 1 and 2 described above illustrate onboarding an application by the third party service provider 208 to the cloud store (and is also discussed in more detail later herein with regard to FIG. 5). After that is completed, a system, such as the exemplary system as shown in FIG. 4, then onboards such application 203 to each end user 207. This is done using the system 400 which is configured to onboard the application developed by the third party service provider 208 and deliver content through such application 203 according to some embodiments.

As illustrated in block 402 of FIG. 4, the third party service providers 208, 208′ onboard applications 203, 203′ to the cloud store 204 as discussed above. The cloud store 204 may then onboard each application 203, 203′ to the end users set top box 413 (as detailed in FIG. 6) and communicate data (e.g., receive content requests, distribute requested content, etc.) regarding the cloud store 204 to/from the network system 202 (e.g., a 5G cellular network system).

The network system 202 then can communicate such data requested by a user either directly to mobile devices 410 (e.g., mobile phone or table) or directly to a gateway 414 of a home or business. The gateway 414 is connected to a set top box 413 to relay communications between the cloud store 204 and the set top box 413.

The set top box 413 is configured to present respective applications of third party service providers 208 that are associated with the user of the set top box 413. In this regard, such users can request content 402 from the third party service provider via the application in the cloud store 204 and/or use the set top box 413 as a two-way communications device to communicate with other set top boxes or other devices, as discussed herein.

The set top box 413 also is configured to receive television content from the television service provider 209 in order to watch television programming. The set top box 413 is connected with a television 415 to display the content output by the set top box 413, whether that be television content from the television service provider 209 or content from the third party service provider 208. In this regard, the television 415 acts as a display for the set top box 413.

The gateway 414 is also configured to relay communications between the cloud store 204 and mobile devices 416, 418 (e.g., mobile phone, tablet, etc.) associated with the user where such mobile devices 416, 418 receive content through the gateway 414. The gateway 414 and/or set top box 413 has an IP address which is associated with a geographic area where the gateway 414 and/or set top box 413 is physically located and such IP address may be transmitted to the cloud store 204 when sending content requests, whereby such location is used to determine what applications 203, 203′ that the user 207 is authorized to use and/or receive content based on geo-targeting limitations.

FIG. 5 illustrates a method of onboarding an application 203 by a third party service provider 208 according to some embodiments. As mentioned above, the cloud store 204 allows a third party service provider 208 to develop an application 203 directly and independently so that the third party service provider 208 can provide content directly to targeted users 207. This process is explained in more detail in the blocks of FIG. 5, provided below.

First, in block 502, a first interface 201 is provided in a cloud store 204. The first interface 201 may include the canvas 220 as well as a the feature set 211 and function set 210 have a series of selectable functions, as discussed above with regard to FIG. 2. As mentioned above, the functions 210 may be individually selected by the third party service provider 208 by dragging and dropping function icons from a list to the canvas 220.

In block 504, the system 200 receives, from the third party service provider 208 using the canvas 220 in the first interface 201, the selection of functions 210 that will be used to build the application 203 in the cloud store 204, as previously discussed in FIG. 2. The system 200 then builds the application 203 using the selection of features 211 and functions 210 from the third party service provider 208, as provided in block 506. According to one embodiment, the application 203 is built by the television service provider 209 which is separate from the third party service provider 208 after the third party service provider 208 provides selections of the functions 210 to be included in the application 203.

Additionally, the application 203 is stored in the cloud store 204, and the application 203 is associated with the user 207 in a database at a server associated with the cloud store 204, in block 510. In other words, the application 203 is stored in association with those users 207 who are authorized to use the application 203, whereby such users 207 are identified to the system 200 by the third party service provider 208 providing a user ID (e.g., user's phone number), as discussed in FIG. 6.

In block 510, a request is received from the user 207 for content from the user's set top box 413 via the application 203. The request may be initiated by the user 207 using the set top box remote control and/or automating targeted push by third party service provider/TV service provider to activate/open the application 203 and activate content to be received at the set top box 413. The set top box 413 then sends a request message from the set top box 413 to a server at the cloud store 204.

The server then processes such request by determining if the user is authorized to receive the requested content. Such determination may be completed by determining if the application 203 is associated with the user 207, performing a check with the third party service provider 208 of user authentication for such content, determining if the user's account has an activation with the application 203, etc.

Whatever the case may be, if the user 207 is determined by the server to be authorized to receive the content, the requested content is delivered from the cloud store 204 (or other server) to the user's set top box 413 over the network 202, as provided in block 512. In this regard, the third party service provider 208 then delivers content through the application 203 by transmitting the content from the third party service provider 208 over the network 202.

While FIG. 5 discusses that the third party service provider 208 builds an application and onboards the application to the cloud store 204, FIG. 6 illustrates onboarding the application to a set top box 413 of a user so that content can be delivered to the set top box 413 (and doing so without the set top box sending a request for such application 203) according to some embodiments.

In block 602, a first interface 201 is provided in a cloud store 204, and the functions 210 may be individually selected by the third party service provider 208 by “dragging and dropping” icons of functions 210 from a list to a canvas 210, as discussed above with regard to block 502 of FIG. 5 and with respect to FIG. 2.

In block 604, the system 200, 400 receives, from the third party service provider 208, the feature/function data (e.g., selections of functions 210′, selection of settings/options 222, etc.) to build the application 203 using the first interface 201 in the cloud store 204. Additionally, the system 200 receives user-identifying data that identifies the user 207 indicating the user 207 is authorized to receive the application 203. This information can be any information identifying the user 207, including information already known to the television service provider 209. For example, the user ID could be the user account number, the user phone number, the user name/address information, the user's email address, the user's governmental ID (e.g., social security number, driver's license number, passport number. etc.), according to various embodiments.

Moreover, as mentioned above, the system 200 determines the geographic location of the user 207, such as, for example, by identifying the location of the IP address of the device requesting the content, according to an embodiment.

In block 606, the application 203 is built using the feature/functions 211, 210 selected by the third party service provider 208, as discussed above with regard to block 506 and in FIGS. 1, 2 and 5 and the above discussion thereof.

In block 608, the television service provider 209 identifies the user 207 by comparing the received user-identifying data (discussed with regard to block 604) with data in a database of the television service provider 209. For example, the user's phone number provided by a yoga instructor is compared with the user's phone number stored with the television service provider 209.

In one embodiment, the application 203 may be stored in the cloud so that the next time that the user 207 accesses the viewing interface for television service provider 209, the user's set top box 413 may request such interface and such interface will have already have been updated to include the application 203 for the user 207. In this embodiment, the television service provider 209 merely updates the entry associated with the user 207 at the cloud server in the system 200.

Moreover, referring back to block 608, the user 207 is determined as to whether he is authorized to receive the requested content. For example, the television service provider 209 identifies the user's geographical location and compares the requesting device's location with a geographic area limitation to determine if the user 207 is within a geographic targeted area in order to determine if the user 207 is authorized to receive the requested content, according to an embodiment. The user 207 is then determined as to whether or not the user 207 is authorized to receive such content. For example, if the user 207 is within a required geo-graphical area authorized by the third party service provider 208 to receive the third party service provider's content, the user 207 is determined to be authorized. Also, if the user 207 is a subscriber to the third party service provider application 203, then the user 207 may be automatically determined to be authorized to receive the content from the third party service provider 208 (e.g., if geographical limitations or other limitations are not set).

In block 610, in response to successfully identifying the user 207 and determining that the user 207 is authenticated to receive the requested content based on a successful result in the determination made in block 608, the application 203 is transmitted or “pushed” to the user's set top box 413 from a server of the cloud store 204 so that when the user 207 views an interface on the user's set top box 413, the application 203 is viewable and usable by the user 207 to receive content from the television service provider 209 through the user's set top box 413.

In order to do this, the user 207 is identified by the television service provider 209 (as mentioned above in block 604), and the television service provider 209 then uses the television service provider's user account information to identify a set top box 413 associated with the user ID information. For example, if number “555-555-5555” is provided by the yoga instructor, the television service provider 209 then uses the television service provider's user account information to identify a set top box 413 associated with “555-555-5555.”

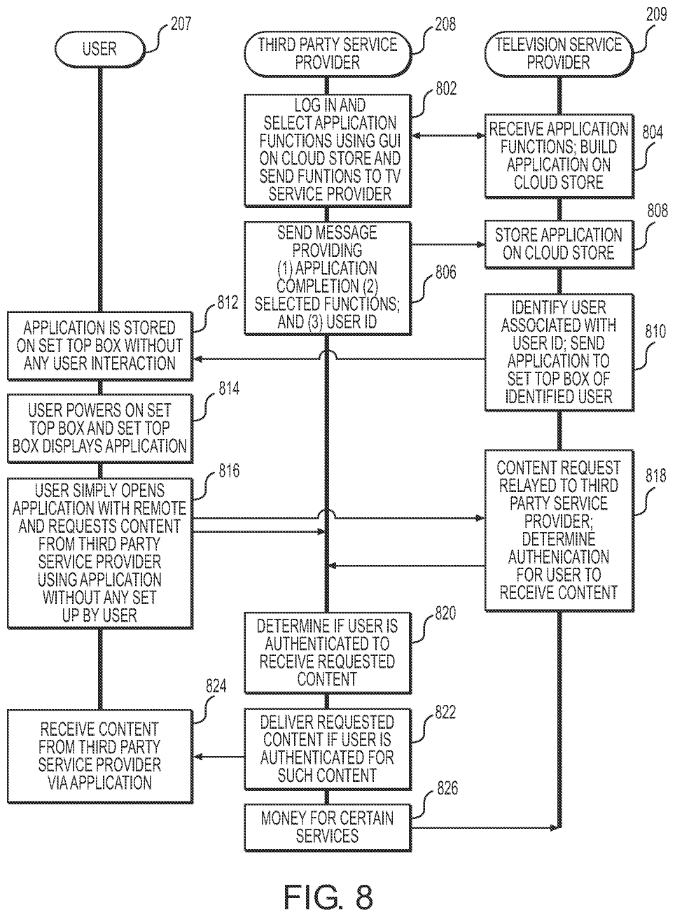

Once the set top box 413 is identified and the address of the set top box 413 is determined, the television service provider 209 then can transmit to and store on the set top box 413 of the user 207 the application of the third party service provider 208 (since the third party service provider 208 has indicated to the television service provider 209 that the user 207 is to be enrolled in the application 203). This is completed without the set top box 413 or the user 207 requesting the application 203 to be install, and as such, the application 203 is simply being pushed to the user's set top box 413. This simplicity for the user is discussed in more detail with regard to FIG. 8.

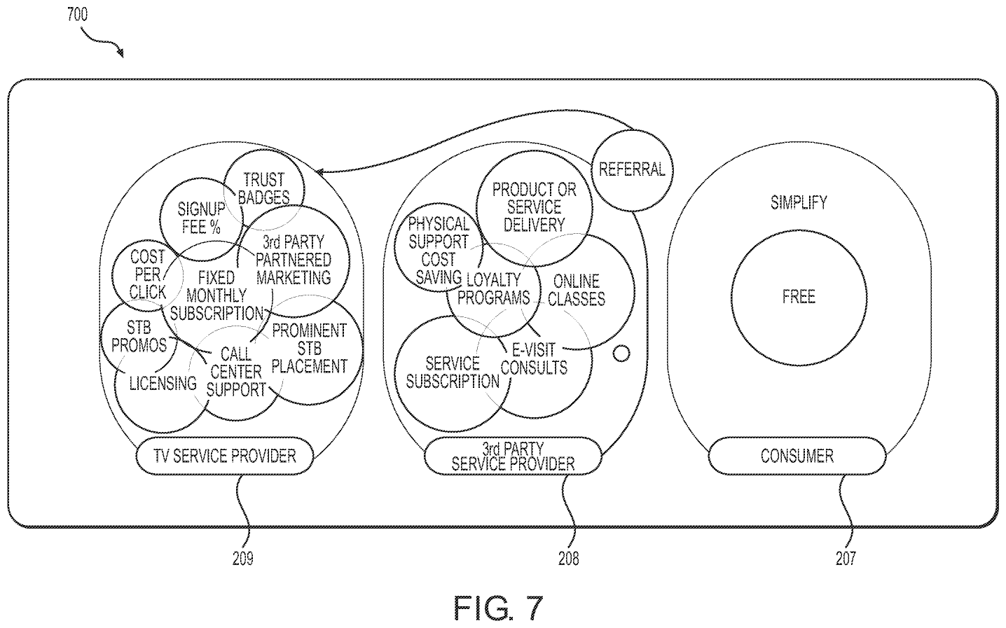

After the application 203 is built and stored, each customized application 203, 203′ is particularly associated with the third party service provider 208, 208′ that developed the application 203, 203′ and the user 207 is provided by such third party service, but the user is not charged any money through the set top box 413 but there is a monetary flow between the television service provider 209 and the third party service provider 208, according to some embodiments. FIG. 7 illustrates a block diagram illustrating a monetary flow of money and charges between the user 207, the television service provider 209, and the third party service provider 208 using the system 200 of the present application according to some embodiments. In this regard, only the users 207 of the third party service provider 208 that developed the application 203 will use the application 203, according to some embodiments.

The various ways for the television service provider 209 to make money includes, for example, cost per click charges, charges for promotions, licensing charges, trust badge charges, marketing charges, monthly subscription charges, signup fees, call center support charges, and so on. For example, the television service provider 209 will collect money from each respective third party service provider 208, 208′ for each click on the respective application 203, 203′ of the respective third party service provider 208, 208′. Also, if the television service provider 209 provides a promotion for the third party service provider 208 during programming or on a guide of the television content provided by the television service provider 209, the third party service provider 208 will be charged a fee. For licensing, the television service provider 209 could license the application 203 developed by the third party service provider 208 to another television service provider (not shown) for the rights to such application program to run on the system of such other television service provider. For the signup fee, the user 207 that signs up for a service of the third party service provider 208 through the application 203 of the third party service provider 208, the television service provider 209 would receive a percentage of such signup fee.

There may also be monthly fees, such as a fixed monthly subscription for the third party service provider 208 so that the third party service provider 208 does not pay individual fees services of the television service provider 209 but instead pays a one-time fee per month. By way of another example, there may be a recurring fee for a call center provided by the television service provider 209 to provide support for the application 203.

There may be marketing charges whereby the television service provider 209 can market the application of the third party service provider 208, such as in commercials of television content broadcasted by the television service provider 209, by targeted ads sent to the user 207 by the television service provider 209, etc. Similarly, the television service provider 209 can place trust badges on the application 203 of the third party service provider 208 to show the application 203 is popular, works effectively, delivers good content, etc. and such trust badges could be another charge to the third party service provider 208.

Each of these fees will be paid only from the third party service provider 208 to the television service provider 209 so that no money is transmitted from the user 207 to the television service provider 209. The television service provider 209 reserves the right to charge a user 207 in the future.

Moreover, each of the above-discussed charges is shown above the television service provider 209 in FIG. 7. Above the third party service provider 208 in FIG. 7 are exemplary ways for the third party service provider 208 to profit. First, because the third party service provider 208 is providing a service to the end user 207, the end user 207 already has a relationship with the third party service provider 208 to pay the third party service provider 208 directly but independent of the system 200 or application 203. Since the user 207 already pays the third party service provider 208, the user 207 can receive online classes and the third party service provider 208 makes money through the application 203 by providing such online classes to the user 207.

Additionally, the application 203 is configured to allow the third party service provider 208 to generate additional revenue sources. For example, the user 207 may add a service subscription for the third party service provider 208 via the application.

Also, the third party service provider 208 may allow e-visits from other providers, such as a doctor, where such other providers would pay the third party service provider 208 for use of the application. Moreover, the service can be one to give notifications and reminders to the user 207 via the application 203, which can be a charge that the third party service provider 208 provides to whoever wants to deliver these notifications to the user 207.

There is also a referral money that the third party service provider 208 can receive from the television service provider 209 if the third party service provider 208 is responsible for the user 207 signing up for services offered by the television service provider 209.

As shown for user 207 in FIG. 7, the user 207 is not charged any fees by the third party provider 208 or the television service provider 209 for using the application 203 (although the television service provider 209 reserves the right to charge user 207 in future). The user 207 is already paying the third party service provider 208 for services outside of the application 203. Again, the system 200 is has stored associated with the user's account the services that the user 207 is allowed to access and the third party service provider 208 gives the user 207 sets the services that the user 207 is allowed to view. However, the user 207 does not perform any setup on the their end so that, when the user 207 requests content, the user 207 is allowed or disallowed for the content based on the setup from the third party service provider 208. In such embodiment, the user is not allowed to change what services he/she is authorized to receive in the application 203—instead this is completely set by the third party service provider 208 in the setup/management of the application 203 for the user (and is pushed to the user from the cloud store 204). This allows a quick use of the application for the user 207 without the user 207 ever having to search, install, maintain, or perform any set up on the application 203.

FIG. 8 illustrates a method of creating, onboarding, and using an application in order to show the simplicity of use for the user 207 and delivering content according to some embodiments. In this regard, there are three entities shown in FIG. 8: the user 207, the third party service provider 208, and the television service provider 209. Each of these entities could individually and independently perform one or more actions or a device associated with each entity could perform an action. For example, for the user 207, either the user 207 could perform an action or the action could be performed by the set top box 413, as appropriate.

In block 802, the third party service provider 208 selections functions 210 to build the application 203 using the GUI 201 in the cloud store. In block 804, the television service provider 209 receives such selected functions 210′ and then builds/compiles the application 203 only using instructions associated with such selected functions 210′.

In block 806, the third party service provider 208 will indicate when the application building process using the canvas 220 is completed. As that point, a message may be sent to the television service provider 209 with the selected functions 210′ and a user ID identifying the user. In some embodiments, the user ID could be a phone number, email, name, account number, etc. of the user, as mentioned above.

In block 808, after the application 203 is built, the application 203 is stored on a server associated with the television service provider 209. Then, in block 810, the user 207 is identified using the received user ID (by comparing the user ID with user IDs stored in a database at the television service provider 209), and the application 203 is sent or “pushed” to the set top box 413 (or other device) associated with the user 207. The application is then stored at the set top box 413 associated with the user in block 812.

Prior to this point, the user 207 has had no interaction with the application 203 and the application 203 has been loaded onto the user's set top box 413 without the user 207 searching, requesting or setting up the application 203.

Blocks 814, 816 and 824 illustrate a method of use by an end user 207 of the application to show the simplicity ease of use of the application 203.

First, in block 814, the user 207 powers on the set top box 814 and the set top box 413 automatically displays the application 203 for automatic use by the user 207 of the set top box 413. The user 207 simply opens the application 203 with the TV remote control (for example) and requests content from the third party service provider 208 using the application 203 developed directly by the third party service provider 208 (and onboarded to the user's set top box 413 by the television service provider 209 without the user's request), as provided in block 816.

The content request may be forwarded to either the television service provider 209 (as shown in block 818) or to the third party service provider 208. In either case, it may be determined whether the user 207 is authorized to receive the requested content based on predefined limitations/settings (e.g., geo-targeting of the application), as shown in blocks 818 or 820. It should be understood that either the third party service provider 208 or the television service provider 209 may look up as to whether the user 207 of the set top box 413 is authorized to receive certain content based on the permissions being stored in a database at the television service provider 209 or at the third party service provider 208.

In any event, if the user 207 is authenticated for the content, the user 207 will receive content from the third party service provider 208 using the application, in block 824.

It is noted that money for services may be transferred from the third party service provider 208 to the television service provider 209 (and/or vice versa) based on certain events occurring.

In any event, it is understood that the user's experience using the application is seamless in that the user does not have to search, request, download, set up or manage the application 203 as the television service provider 209 and the third party service provider 208 builds, sets up and installs the application 203 for the user 207 so that the user only needs to use the application 203, according to various embodiments. However, in some embodiments, the user 207 can be provided with an interface to provide searching on the cloud store 204 for applications 203 and request to download the application 203 and the present invention should not be limited in this regard.

The user 207 can take advantage of various features of the application 203 in a convenient manner. For example, if the user 207 wants to communicate via TVs between rooms in a hotel or a nursing home, the user 207 can simply pick up his remote control, click a pre-installed application 203 built by the hotel owners or the nursing home owners, and request a call to another user in another room. This will ring the other room's television. If such television is off, it would turn the television on and ring the television.

In another example, if the user 207 wants to check on his mother using a health application 203 built by company X, he can simply ring his mother's television using his television using his set top box 413 (or use his tablet). The call will turn on the television if the television is off and ring the speakers to notify his mother of an incoming call. However, if his mother is watching a program, the call will interrupt, pause or be concurrent with the television program to notify his mother of the incoming call. His mother would have the same application 203 that her son would have. The call could be displayed in picture in picture (PiP) so the user 207 can see multiple screens on the television (e.g. the caller, the user 207 and the live video that was originally playing on the television)

In another embodiment, one may pay a yoga instructor monthly for in person yoga classes. The yoga instructor may develop the application 203 in the cloud store 204 and send the user's phone number to the television service provider 209. In this regard, the yoga instructor's application 203 will be automatically pushed and stored on the user's set top box 413 (or mobile device) for future use. Various notifications could be displayed for the user 207 while the user 207 is watching programming as the application 203 is integrated in with the television content provided by the television service provider 209. This could be performed by displaying a banner on the bottom of the screen, interrupting the programming to let the user know of an upcoming class, or the like. The user 207 would not pay the television service provider 209 anything for this application since the user 207 pays the yoga instructor directly. The user 207 simply loads the application and gets notifications without the user having to install the application or perform any setup.

Another example may be a hospital being the third party service provider 208 and developing an application 203 for a user, Mary who is subscriber to television services from television service provider 209. The application 203 may have a medication reminder, blood pressure reminder and allow calls. First, for the medication reminder, Mary may be up early and turns on the TV so it's on in the background while she's doing chores. Sometime before 9 am, she sits down in front of TV to catch up on the news. At 9 am, a popup appears on the screen, accompanied by a chime and a narration:

“Hi Mary, It's time to take your heart medication. Please take one capsule of Captopril with a glass of water. I've paused your program so you won't miss anything in the meantime. Say ‘Done’ into the voice remote or select ‘Done’ once you've taken the medicine.”

Mary complies, takes the medicine, then says ‘Done’ into the voice remote. The popup disappears and the news program is resumed and confirmation is transmitted to third party service provider 208.

Second, for the blood pressure reminder, Mary is back from a walk before 6 pm; the TV is off (in standby). At 6 pm (scheduled), Mary hears a chime and the TV turns on. A popup message appears with a reminder to check blood pressure:

“Hi Mary, It's time for your blood pressure check! Please take your blood pressure and say ‘Ready’ into the voice remote once you have your measurement.”

Mary takes blood pressure and says ‘Ready’ into the voice remote. “OK, tell me what your blood pressure is. For example, you can say ‘130 over 80.’” Mary says ‘135 over 85’ into the voice remote. “OK, I will record your blood pressure as 135 over 85.” At this point the popup disappears and the TV goes back into standby, and Mary goes on with her day and confirmation is transmitted to third party service provider 208

Mary may also make outbound video calls with the application 203. Mary picks up the voice remote while in front of the TV and says ‘Make a video call to Lisa’ into the remote. She hears the voice response from the TV: “OK, I'm making a call to Lisa.” In a few moments, Mary sees Lisa on the screen and proceeds with the video call. After they finish the call, Mary returns to watching live TV. In another scenario, Mary is able to click on a call-to-action button on the third party service provider 208 application directly from their TV to place a video call to Lisa or her healthcare provider to seek assistance, including in an emergency. The video calling interface may also have ability to text chat and share pictures, blood pressure readings etc.

Although specific embodiments were described herein, the scope of the invention is not limited to those specific embodiments. The scope of the invention is defined by the following claims and any equivalents therein.

As will be appreciated by one skilled in the art, aspects of the present disclosure may be embodied as a system, a method or a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

What is claimed is:

1. A set top box to deliver content from a television service provider to a user, the content being developed by a third party service provider, the set top box comprising:
a receiver for onboarding an application to the set top box from a cloud store over a network, wherein the application has been onboarded to the cloud store from the third party service provider in response to the application being developed directly by the third party service provider using a first interface provided by a television service provider ; and
a second interface for transmitting a request to and from the user for content using the application to a television of the user over the network;
wherein, in response to receiving the request from the set top box, the receiver receives, from the television service provider, content requested by the user.

2. The set top box of claim 1, wherein:
the cloud store is configured to receive, from the third party service provider, (1) feature data to build the application using the first interface in the cloud store, and (2) user-identifying data that identifies the user indicating the user is authorized to receive the application, and
in response to successfully identifying the user, the application is sent by a server of the cloud store to the set top box so that when the user views an interface on the user's set top box, the application is usable by the user to request content from the television service provider through the user's set top box.

3. The set top box of claim 1, wherein the application is onboarded to the user's set top box without the user searching for or requesting the application from the cloud store.

4. The set top box of claim 1, wherein use data is collected by the television service provider from the third party service provider when the application is used by the user, and the use data is used to charge money from the third party service provider, instead of the user, based on use of the application by the user.

5. The set top box of claim 1, wherein the cloud store is configured to communicate content from a server to the set top box over a satellite system and/or through a wifi or cellular network.

6. The set top box of claim 1, wherein:
a server at the cloud store identifies that settings of the application requires the user be within a geographic area for the user's set top box to receive content,
the server receives location data identifying a location of the user; and
the server delivers the content to the user's set top box only in response to determining the user's location is within the geographic area.

7. A method of delivering content from a content provider to a set top box of a user, the content being developed by a third party service provider, the method comprising:
providing a first interface in a cloud store for onboarding an application of a third party service provider;
receiving, from the third party service provider, (1) feature data to build the application using the first interface in the cloud store, and (2) user-identifying data that identifies the user indicating the user is authorized to receive the application;
building the application using the feature data from the third party service provider;
identifying, by the television service provider, the user by comparing the received user-identifying data with data in a database of the television service provider; and
in response to successfully identifying the user, onboarding the application to the user's set top box from a server of the cloud store so that when the user views an interface on the user's set top box, the application is configured to allow the user to request content from the third party service provider through the user's set top box.

8. The method of claim 7, wherein the application is onboarded to the user's set top box without the user searching for or requesting the application from the cloud store.

9. The method of claim 7, wherein use data is collected by the television service provider from the third party developer when the application is used by the user, and the use data is used to charge money from the third party service provider, instead of the user, based on use of the application by the user.

10. The method of claim 7, wherein:
identifying that the application requires the user be within a geographic area to receive content;
receiving location data identifying a location of the user; and
performing the delivering in response to determining the user's location is within the geographic area.

11. A method of delivering content from a content provider to a set top box of a user, the content being developed by a third party service provider, the method comprising:
providing a first interface in a cloud store for onboarding an application of a third party service provider, the first interface comprising a feature set of features and each feature within the feature set comprising a set of functions that are individually selectable by the third party service provider;
receiving, from the third party service provider using a canvas in the first interface, a selection of functions that will be used to build the application in the cloud store;
building, by the television service provider, the application using the selection of functions from the third party service provider;
storing the application in the cloud store;
associating the application with the user in a database at a server associated with the cloud store;
receiving a request for content from a user's electronic device, the request being performed using the application, and the user's electronic device comprising a processor; and
delivering the requested content to the user's electronic device.

12. The method of claim 11, wherein the application is onboarded to a user's set top box without the user searching for or requesting the application from the cloud store.

13. The method of claim 11, further comprising:
identifying that the application requires the user be within a geographic area to receive content;
receiving location data identifying a location of the user; and
performing the delivering in response to determining the user's location is within the geographic area.

14. The method of claim 11, further comprising:
receiving, from the third party service provider, user-identifying data that identifies the user indicating the user is authorized to receive the application;
identifying, by the television service provider, the user by comparing the received user-identifying data with data in a database of the television service provider; and
in response to successfully identifying the user, onboarding the application to a user's set top box from a server of the cloud store so that when the user views an interface on the user's set top box, the application is usable by the user to request content from the television service provider through the user's set top box.

15. The method of claim 11, further comprising:
collecting data based on the user using the application;
determining fees associated with such collected data; and
charging the third party server provider based on the determined fees but not charging the user.

16. The method of claim 11, wherein the user's electronic device comprises at least one of a cellular phone, tablet, set top box, television or computer.

17. The method of claim 16, wherein the user's electronic device receives the content directly from a connectivity source comprising one of a satellite system, a wifi network, or cellular network, while the set top box receives the content.

18. The method of claim 11, wherein the cloud store is configured to communicate content from a server to the set top box over a satellite system and through a 5G network.

19. The method of claim 11, wherein the third party service provider uses the first interface to drag and drop icons representing the functions to the canvas.

20. The method of claim 19, wherein the third party application visibility can be flexible to the user on their devices using the television service provider set top box.
